(19) United States
(12) Patent Application Publication
(10) Pub. No.: US 2019/0325121 A1
(43) Pub. Date: Oct. 24, 2019

(54) USER AUTHENTICATION SYSTEM AND USER AUTHENTICATION METHOD FOR PERFORMING USER AUTHENTICATION BY BIOMETRIC AUTHENTICATION

(71) Applicant: KYOCERA Document Solutions Inc., Osaka (JP)

(72) Inventor: Shunsuke MORI, Osaka (JP)

(73) Assignee: KYOCERA Document Solutions Inc., Osaka (JP)

(21) Appl. No.: 16/388,461

(22) Filed: Apr. 18, 2019

(30) Foreign Application Priority Data
Apr. 18, 2018 (JP) 2018-079767

(51) Int. Cl. G06F 21/32; H04L 29/06; G06F 3/12; H04W 4/80

(52) U.S. Cl. CPC G06F 21/32; H04W 4/80; G06F 3/1292; H04L 63/0861

(57) ABSTRACT

Provided is a user authentication system that suppresses an increase in operation costs. A portable terminal performs short-range wireless communication by a communication control unit, performs biometric authentication of a user by a biometric authenticating unit, and by a system control unit instructs a communication control unit to transmit login request information including user identification information when biometric authentication by the biometric authenticating unit is successful. An MFP performs short-range wireless communication by a communication control unit, and by a system control unit permits a user indicated by the user identification information included in the login request information to login after receiving the login request information. As a result, indirect biometric authentication becomes possible by using the authentication result of biometric authentication by a portable terminal without addition of a biometric authenticating unit, update of firmware, data registration of biometric information called a template, and the like.

### INCORPORATION BY REFERENCE

This application is based on and claims the benefit of priority from Japanese Patent Application No. 2018-079767 filed on Apr. 18, 2018, the contents of which are hereby incorporated by reference.

### BACKGROUND

The present disclosure relates to a user authentication system and a user authentication method for performing user authentication by biometric authentication.

For example, in an image forming apparatus such as a multifunctional printer, MFP (Multifunction Peripheral), or the like, confidential documents and the like are sometimes handled. Therefore, in the image forming apparatus, from the viewpoint of preventing information leakage, there are many models equipped with a user authentication function. Incidentally, the user authentication includes authentication by input of user identification information such as user ID (identification) and the like, biometric authentication using physical characteristics of a user, and the like.

Here, as an image forming apparatus equipped with biometric authentication, in typical technology there is a secure printing system. In this secure printing system, when a control unit of the image forming apparatus confirms that biometric information inputted by a biometric information inputting unit matches registered biometric information from a portable communication apparatus acquired by short-range wireless communication, printed matter is generated and discharged to a discharge tray.

### SUMMARY

A user authentication system according to the present disclosure includes a portable terminal and image forming apparatus. The portable terminal has a first communication control unit, a biometric authenticating unit, and a first system control unit. The first communication control unit performs short-range wireless communication. The biometric authenticating unit performs biometric authentication of a user. The first system control unit instructs the first communication control unit to transmit login request information including user identification information when biometric authentication by the biometric authenticating unit is successful. The image forming apparatus has a second communication control unit and a second system control unit. The second communication control unit performs short-range wireless communication. The second system control unit, after receiving the login request information, permits a user indicated by the user identification information included in the login request information to login.

The user authentication method according to the present disclosure executes the following steps by a portable terminal and an image forming apparatus. The portable terminal has a step of performing short-range wireless communication by a first communication control unit. The portable terminal has a step of performing biometric authentication of a user by a biometric authenticating unit. The portable terminal has a step of issuing an instruction by a first system control unit to the first communication control unit to transmit login request information including user identification information when biometric authentication by the biometric authenticating unit is successful. The image forming apparatus has a step of performing short-range wireless communication by a second communication control unit. The image forming apparatus has a step of permitting by a second control unit a user indicated by the user identification information included in the login request information to login after receiving the login request information.

### BRIEF DESCRIPTION OF THE DRAWINGS

FIG. 1 is a diagram for explaining an embodiment of a user authentication system according to the present disclosure.

FIG. 2 is a diagram for explaining an example of configuration of the MFP and the portable terminal in FIG. 1.

FIG. 3 is a diagram illustrating an example of a distance determination graph to be referred to when the system control unit of the MFP illustrated in FIG. 2 determines the position of the portable terminal.

FIG. 4 is a flowchart for explaining processing on the portable terminal side in FIG. 1.

FIG. 5 is a flowchart for explaining processing on the MFP side in FIG. 1.

### DETAILED DESCRIPTION

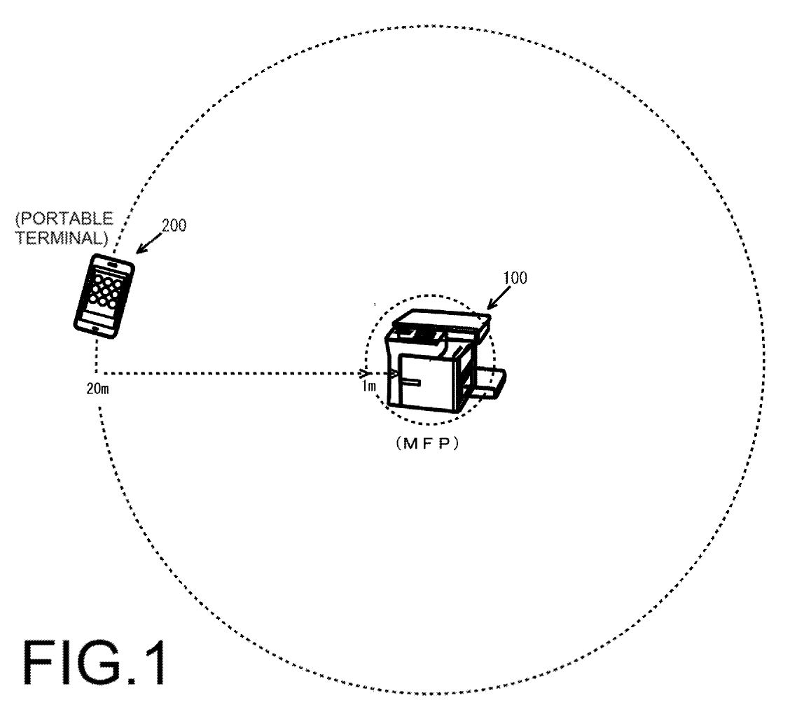

Hereinafter, an embodiment of the user authentication system according to the present disclosure will be described with reference to FIG. 1 to FIG. 5. Note that the user authentication system in the following description includes an image forming apparatus and a portable terminal. As an example of the image forming apparatus, it is presumed that the image forming apparatus is an MFP (multifunction peripheral), which is a complex peripheral apparatus equipped with, for example, a printing function, a copying function, a FAX function, a data transmitting and receiving function via a network, and the like. As the portable terminal, a smartphone, a tablet, or the like may be used.

In other words, as illustrated in FIG. 1, the user authentication system includes a MFP 100 and a portable terminal 200. The MFP 100 exchanges data with the portable terminal 200 by short-range wireless communication. As the short-range wireless communication, for example, a communication method using radio waves in the 2.4 GHz band, which is the communication standard of Bluetooth (registered trademark), can be used. In addition, for convenience of explanation, the distance in which the short-range wireless communication between the MFP 100 and portable terminal 200 is possible is, for example, within 20 m. Moreover, in the Bluetooth (registered trademark) communication standard, communication by frequency hopping is specified in order to avoid the influence of noise. However, since frequency hopping is well known, an explanation is omitted here. In addition, in short-range wireless communication between the MFP 100 and the portable terminal 200, infrared communication may be used. Furthermore, in a case where both the MFP 100 and the portable terminal 200 are compatible with Wi-Fi Direct (registered trademark), data exchange may be performed by wireless communication using Wi-Fi Direct (registered trademark).

Note that it is presumed that connection settings for the MFP 100 and the portable terminal 200 have been completed by pairing. In this case, it is presumed that the MFP 100 operates as a master and the portable terminal 200 operates as a slave. In addition, the MFP 100 may be equipped with an authentication function by input of user identification information such as a user ID (identification) or the like, and a biometric authentication function. Moreover, the MFP 100 may be equipped with only an authentication function by input of user identification information such as a user ID or the like. In the present embodiment, for convenience of explanation, it is presumed that the MFP 100 is not equipped with a biometric authentication function.

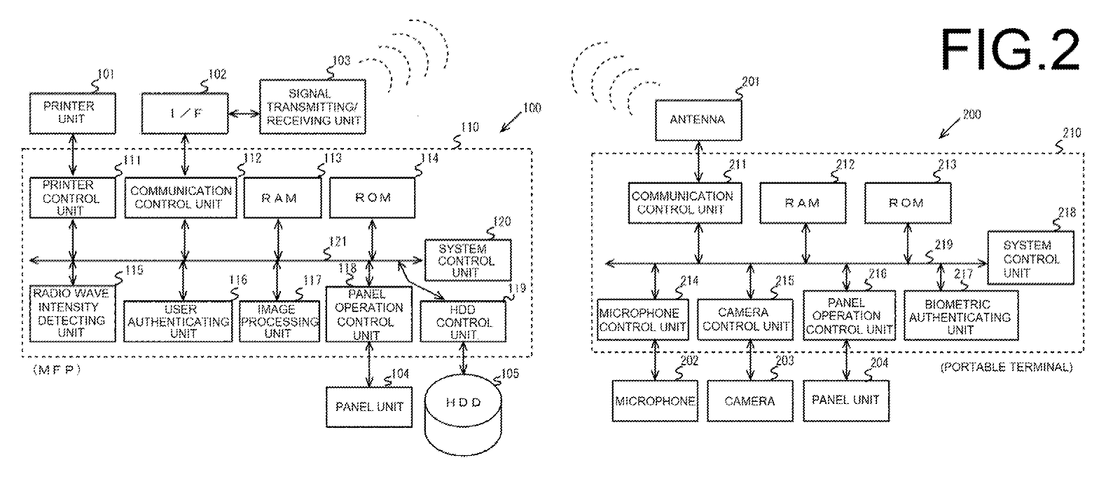

On the other hand, the portable terminal 200 is equipped with a biometric authentication function. In addition, the portable terminal 200 holds user identification information such as a user ID (identification) or the like that is received from the MFP 100 and managed by the user authenticating unit 116 (refer to FIG. 2 described later). Note that the user identification information here corresponds to a user possessing the portable terminal 200. When biometric authentication is successful, the portable terminal 200 transmits login request information to the MFP 100 using radio waves of the 2.4 GHz band, which is the communication standard of Bluetooth (registered trademark). The login request information referred to here is information for logging in to the MFP 100 and includes user identification information received from the MFP 100. As a result, after receiving the login request information including the user identification information from the portable terminal 200, the MFP 100 that is not equipped with the biometric authentication function permits login of the user indicated by the user identification information. This will be described in detail later.

Incidentally, from the viewpoint of security, it is preferable that the timing at which the MFP 100 permits login is when the portable terminal 200 comes near the MFP 100. In other words, when the MFP 100 permits login at a position where the user in possession of the portable terminal 200 that transmits the login request information is separated a far distance from the MFP 100 (for example, 20 m), there is a possibility that a third party near the MFP 100 may be able to use the MFP 100. Therefore, from the viewpoint of security, it is preferable that permission for login to the MFP 100 be executed when the user in possession of the portable terminal 200 that transmits the login request information is located near the MFP 100 (for example, within 1 m). In this case, the MFP 100 may determine the position of the portable terminal 200 that transmits the login request information based on the intensity (dBm) of the radio waves from the portable terminal 200. As a result, when the user in possession of the portable terminal 200 that transmits the login request information is nearby, the MFP 100 may execute login permission.

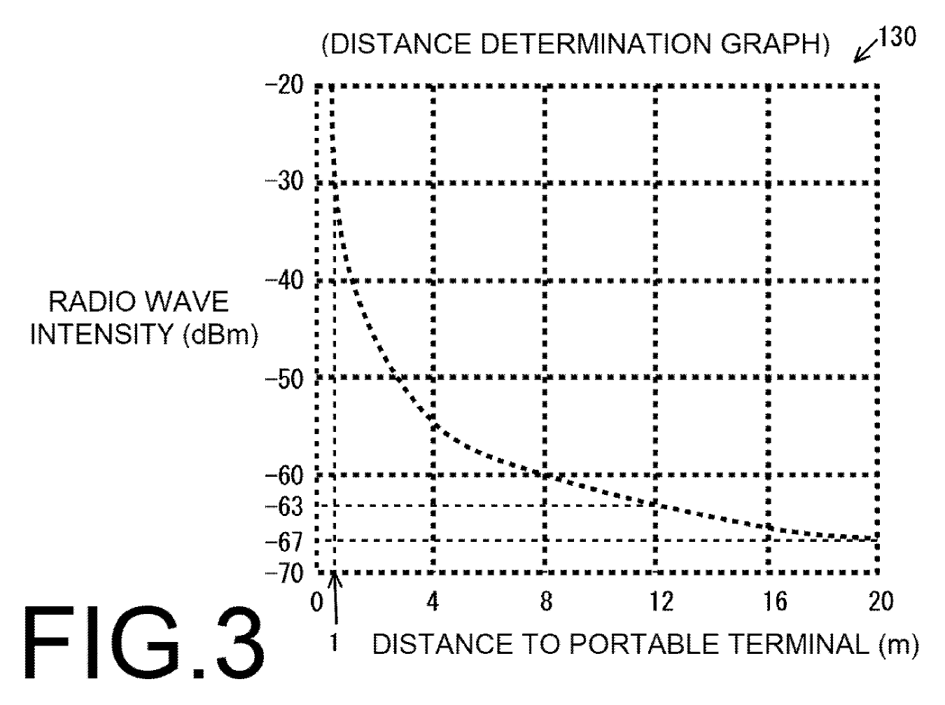

In this case, radio waves from the portable terminal 200 are transmitted at specific intervals (for example, at intervals of one second) with a specific output. On the MFP 100 side, radio waves from the portable terminal 200 transmitted at specific intervals (for example, at intervals of one second) are received. Then, the MFP 100 detects the intensity (dBm) of the radio waves and determines the position of the portable terminal 200 (hereinafter, “intensity of the radio waves” means the intensity of the radio waves from the portable terminal 200 received by the MFP 100). Furthermore, the distance at which the MFP 100 can receive radio waves from the portable terminal 200 is, for example, within a radius of 20 m. In addition, at a position at a radius of 20 m, the main body of the MFP 100 can be visually confirmed. The MFP 100 may determine that the position of the portable terminal 200 is at a position at a radius of 20 m by detecting the intensity (dBm) of the radio waves received from the portable terminal 200. In this case, when the position of the portable terminal 200 is at a 20 m radius, the MFP 100 is set so as to notify the portable terminal 200 of a warning indicating that the user is at a position that is far from the MFP 100. As a result, it is possible to prompt the user in possession of the portable terminal 200 to move to the vicinity of the MFP 100. Incidentally, the intensity (dBm) of the radio waves transmitted from the portable terminal 200 from a position at a radius of 20 m is set to, for example, −67 dBm (refer to FIG. 3). Then, when the intensity (dBm) of the detected radio waves is −67 dBm, the MFP 100 can immediately issue a warning notice to the portable terminal 200 indicating that the user is at a position far from the MFP 100.

Moreover, a case will be described in which the position at which the main body of the MFP 100 can be visually checked is less than a radius of 20 m. In this case, by performing a setting to only execute preparation for permitting login of the user indicated by the user identification information included in the login request information from the portable terminal 200, login can be permitted immediately when the portable terminal 200 comes nearby. Incidentally, the intensity (dBm) of radio waves transmitted from the portable terminal 200 from a position of a radius of 12 m for example, is set to, for example, −63 dBm (refer to FIG. 3). Then, when the intensity (dBm) of the detected radio waves is −63 dBm, the MFP 100 can execute preprocessing (preparation for permitting login) for permitting login. In addition, it is presumed that the intensity (dBm) of the radio waves from the portable terminal 200 transmitted from a position of a radius of 1 m is set to, for example, −30 dBm (refer to FIG. 3). Then, when the intensity (dBm) of the radio waves detected by the MFP 100 is −30 dBm, the user in possession of the portable terminal 200 that transmits the login request information is in the vicinity of the MFP 100. Therefore, by setting the MFP 100 so as to permit the login of the user indicated by the user identification information, it is possible to enhance the convenience of the user while maintaining security.

Next, an example of the configuration of the MFP 100 and portable terminal 200 will be described with reference to FIG. 2. First, the MFP 100 includes a control unit 110 that controls a printer unit 101, an I/F (interface) 102, a signal transmitting/receiving unit 103, a panel unit 104, and a HDD (Hard Disk Drive) 105. The MFP 100 may also include a scanner unit, a FAX unit, and the like.

The printer unit 101 is a device that prints an image on paper based on printing data outputted from the control unit 110. The I/F 102 is in charge of communication with the portable terminal 200 via a network. Incidentally, the I/F 102 may also be in charge of communication with a content server, a web server, or the like. In addition, the I/F 102 is in charge of communication with the portable terminal 200 via the signal transmitting/receiving unit 103 by the Bluetooth (registered trademark) communication method of short-range communication.

The signal transmitting/receiving unit 103 transmits and receives a signal by radio waves based on the Bluetooth (registered trademark) communication method. The panel unit 104 is a device such as a touch panel or the like that performs a printing function, a copy function, a FAX function, a data transmission/reception function via a network, and a display for various settings of the MFP 100.

The HDD 105 is a storage device that stores application programs and the like for providing various functions of the MFP 100. In addition, the HDD 105 also stores user identification information that will become a master for comparison with user identification information such as a user ID or the like that is included in the login request information transmitted from the portable terminal 200.

The control unit 110 is a processor that controls the overall operation of the MFP 100 by executing an image forming program, a control program, and the like. The control unit 110 includes a printer control unit 111, a communication control unit 112, a RAM (Random Access Memory) 113, a ROM (Read-Only Memory) 114, a radio wave intensity detecting unit 115, a user authenticating unit 116, an image processing unit 117, a panel operation control unit 118, an HDD control unit 119, and a system control unit 120. In addition, these units are connected to a data bus 121. The printer control unit 111 controls the printing operation of the printer unit 101. The communication control unit 112, via the I/F 102, controls transmission and reception of data and the like via a network. In addition, the communication control unit 112, via the I/F 102, controls the operation of the signal transmitting/receiving unit 103. The RAM 113 is a work memory for executing a program. The ROM 114 stores a control program for performing an operation check and the like for each unit. The radio wave intensity detecting unit 115 detects the intensity (dBm) of the radio waves based on the communication standard of Bluetooth (registered trademark) transmitted from the portable terminal 200. The user authenticating unit 116 performs user authentication for user identification information such as a user ID or the like inputted via the panel unit 104, for example.

The image processing unit 117 performs image processing (rasterizing) on data files such as document data or the like registered in a document box of the HDD 105, for example. Note that the system control unit 120 temporarily stores the printing data that has undergone image processing by the image processing unit 117 in the RAM 113. The panel operation control unit 118 controls the display operation of the panel unit 104. In addition, the panel operation control unit 118, via the panel unit 104, receives settings such as start of printing, copying, FAX, data transmission/reception via a network, and the like. The HDD control unit 119 controls reading, writing and the like of data to and from the HDD 105.

The system control unit 120 controls the cooperative operation of each unit. In addition, upon receiving, for example, a printing instruction from the panel unit 104 or the portable terminal 200, the system control unit 120 issues an image processing instruction to the image processing unit 117, issues a printing instruction for printing by the printer unit 101 to the printer control unit 111, and the like. Moreover, a case will be explained in which the system control unit 120 receives login request information from the portable terminal 200 when the intensity (dBm) of the radio waves detected by the radio wave intensity detecting unit 115 is less than a specific level (for example, less than −30 dBm). In this case, the system control unit 120 performs preparation to permit the user indicated by the user identification information to login. This will be described in detail later. Furthermore, a case will be explained in which the system control unit 120 receives login request information from the portable terminal 200 when the intensity (dBm) of the radio waves detected by the radio wave intensity detecting unit 115 is equal to or higher than a specific level (for example, equal to or higher than −30 dBm). In this case, the system control unit 120 permits the user indicated by the user identification information to login.

The portable terminal 200 is provided with a control unit 210 for controlling an antenna 201, a microphone 202, a camera 203, and a panel unit 204. The antenna 201 transmits and receives radio waves to and from a radio base station. Moreover, the antenna 201 transmits radio waves of the 2.4 GHz band, which is the communication standard of Bluetooth (registered trademark), with a specific output. In addition, when both the MFP 100 and the portable terminal 200 are compatible with Wi-Fi Direct (registered trademark), the antenna 201 may transmit radio waves based on the communication standard of Wi-Fi Direct (registered trademark) with a specific output. The microphone 202 captures sound. The camera 203 captures images. The panel unit 204 displays contents and the like for instructing the MFP 100 to perform login processing.

The control unit 210 is a processor that controls the overall operation of the portable terminal 200 by executing a control program and the like. The control unit 210 includes a communication control unit 211, a RAM 212, a ROM 213, a microphone control unit 214, a camera control unit 215, a panel operation control unit 216, a biometric authenticating unit 217, and a system control unit 218. In addition, these units are connected to a data bus 219.

The communication control unit 211, via the antenna 201, controls transmission and reception of data and the like via the network. In addition, the communication control unit 211, via the antenna 201, transmits radio waves of the 2.4 GHz band, which is the communication standard of Bluetooth (registered trademark), with a specific output. Note that the communication control unit 211 includes login request information in the radio waves transmitted via the antenna 201. Moreover, the communication control unit 211 includes user identification information such as a user ID or the like received from the MFP 100 in the login request information. The RAM 212 is a work memory for executing programs. The ROM 213 stores a control program for performing an operation check and the like of each unit. The microphone control unit 214 controls the pick-up of sound by the microphone 202. The camera control unit 215 controls capturing of images by the camera 203. The panel operation control unit 216 controls the display operation of the panel unit 204.

The biometric authenticating unit 217, for example, performs biometric authentication by comparing a characteristic portion of a face image of a user captured by the camera 203 with a characteristic portion of a master image stored in the ROM 213. Incidentally, in biometric authentication by the biometric authenticating unit 217, any one of fingerprint authentication, vein authentication, handprint validation, and iris authentication may be executed. Fingerprint authentication uses a fingerprint of a finger. Vein authentication uses blood vessels of veins flowing in hands and the like. Handprint authentication uses the shape of a hand. Iris authentication uses the iris in an eye. The system control unit 218 controls the cooperative operation of each unit. Moreover, the system control unit 218, via the communication control unit 211, transmits radio waves of the 2.4 GHz band, which is the communication standard of Bluetooth (registered trademark). In addition, when there is a login instruction to the MFP 100 via the panel unit 204, the system control unit 218 instructs the biometric authenticating unit 217 to perform biometric authentication. Incidentally, the system control unit 218 instructs the biometric authentication unit 217 to perform either face authentication or voice authentication as biometric authentication. Moreover, when the biometric authentication by the biometric authenticating unit 217 is successful, the system control unit 218 includes login request information having user identification information such as a user ID or the like in the radio waves, and causes the radio waves to be transmitted. Furthermore, after including the login request information in the radio wave and transmitting the radio waves, the system control unit 218 transmits radio waves of a specific output at specific intervals (for example, at intervals of one second). Note that when the system control unit 218 selects logoff to the MFP 100 via the panel unit 204, or when receiving a notification of logoff from the MFP 100, the system control unit 218 stops the transmission of the radio waves of the specific output.

Next, an outline of the intensity (dBm) of the radio waves of the 2.4 GHz band, which is the communication standard of Bluetooth (registered trademark), transmitted by the portable terminal 200 will be described with reference to FIG. 3. Note that FIG. 3 illustrates an example of a distance determination graph to be referred to when the position of the portable terminal 200 is determined by the system control unit 120 of the MFP 100 based on the intensity (dBm) of the radio waves detected by the radio wave intensity detecting unit 115. In the distance determination graph 130 illustrated in FIG. 3, the horizontal axis indicates the distance (m) to the portable terminal 200, and the vertical axis indicates the intensity (dBm) of the radio waves transmitted by the portable terminal 200.

In other words, the intensity (dBm) of the radio waves transmitted by the portable terminal 200 attenuates in inverse proportion to the square of the distance. Here, in a case where the radio wave intensity detecting unit 115 detects the intensity (dBm) of the radio waves to be −30 dBm (0.001 mW), for example, the system control unit 120 determines from the distance determination graph 130 that the distance to the portable terminal 200 is 1 m for example. In addition, in a case where the radio wave intensity detecting unit 115 detects the intensity (dBm) of the radio waves to be −63 dBm (0.00000005 mW), for example, the system control unit 120 determines from the distance determination graph 130 that the distance to the portable terminal 200 is 12 m for example. Moreover, in a case where the radio wave intensity detecting unit 115 detects the intensity (dBm) of the radio waves to be −67 dBm (0.00000001 mW), for example, the system control unit 120 determines from the distance determination graph 130 that the distance to the portable terminal 200 is 20 m for example. Therefore, when the distance where the short-range wireless communication between the MFP 100 and the portable terminal 200 is possible is within 20 m, for example, as described above, the system control unit 120 is such that the radio wave intensity detecting unit 115 detects the intensity (dBm) of the radio waves. As a result, it is possible to immediately determine that the position of the portable terminal 200 is within 20 m.

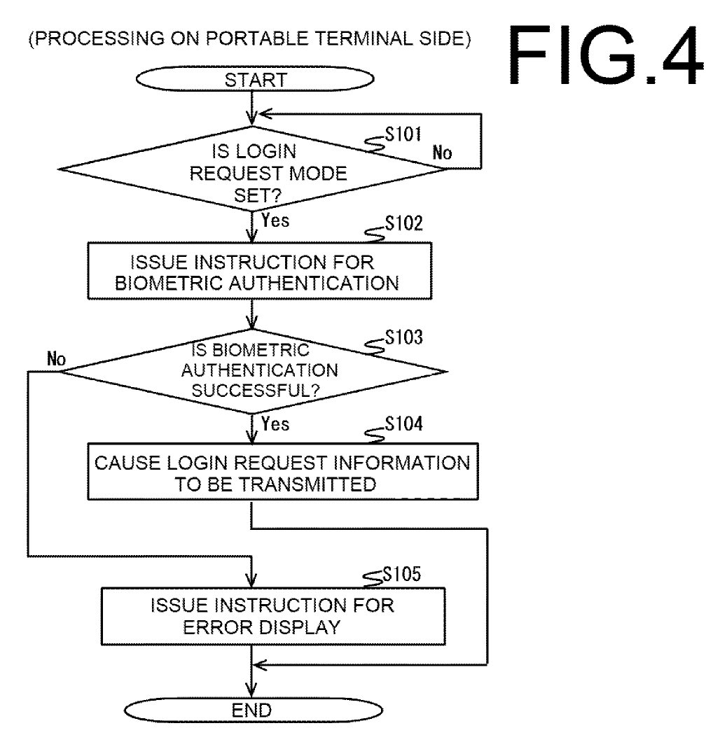

Next, processing on the portable terminal 200 side will be described with reference to FIG. 4. Note that in the following description, when the portable terminal 200 is set to the login request mode, radio waves of the 2.4 GHz band, which is the communication standard of Bluetooth (registered trademark), are transmitted at a specific level and at specific intervals (for example, at intervals of 1 second). In addition, the login request mode is a state in which, after login to the MFP 100 is selected using the panel unit 204 of the portable terminal 200, the system control unit 218 can transmit the login request information to the MFP 100. Moreover, in the following description, it is presumed that the biometric authenticating unit 217 of the portable terminal 200 performs biometric authentication by face authentication.

### (Step S101)

The system control unit 218 determines whether or not the login request mode is set.

In this case, the system control unit 218 determines that the login request mode is not set when there is no notification indicating that the selection of login to the MFP 100 has been received from the panel operation control unit 216 via the panel unit 204 (step S101: NO).

On the other hand, the system control unit 218 determines that the login request mode is set when there is a notification indicating that the selection of login to the MFP 100 has been received from the panel operation control unit 216 via the panel unit 204 (step S101: YES), and processing proceeds to step S102.

### (Step S102)

The system control unit 218 issues an instruction for biometric authentication.

In this case, the system control unit 218 causes the panel unit 204 to display an authentication screen prompting the user to perform authentication of a face image. Then, after the camera control unit 215 controls the camera 203 so as to acquire a face image of the user, the system control unit 218 instructs the biometric authenticating unit 217 to perform biometric authentication.

At this time, the biometric authenticating unit 217 performs biometric authentication by comparing a characteristic portion of the face image of the user captured by the camera 203 with, for example, a characteristic portion of a master image stored in the ROM 213.

### (Step S103)

The system control unit 218 determines whether or not the biometric authentication is successful.

In this case, when contents of a notification from the biometric authenticating unit 217 indicate that the biometric authentication has not been successful, the system control unit 218 determines that the biometric authentication is not successful (step S103: NO), and processing proceeds to step S105.

However, when contents of a notification from the biometric authenticating unit 217 indicate that the biometric authentication has been successful, the system control unit 218 determines that the biometric authentication is successful (step S103: YES), and processing proceeds to step S104.

### (Step S104)

The system control unit 218 causes the login request information to be transmitted.

In this case, the system control unit 218 causes the communication control unit 211 to transmit login request information including user identification information such as the user ID or the like received from the MFP 100.

At this time, the communication control unit 211 transmits the login request information including the user identification information such as a user ID or the like by radio waves of the 2.4 GHz band, which is the communication standard of Bluetooth (registered trademark).

### (Step S105)

The system control unit 218 issues an instruction for an error display.

In this case, the system control unit 218 instructs the panel operation control unit 216 to display an error display on the panel unit 204.

At this time, the panel operation control unit 216 performs an error display on the panel unit 204 and prompts the user to retry the biometric authentication.

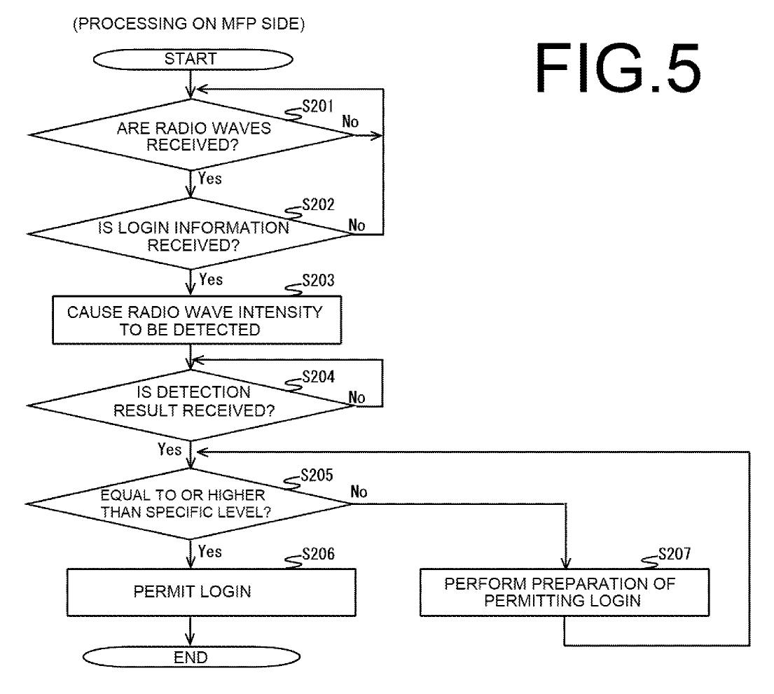

Next, processing on the MFP 100 side will be described with reference to FIG. 5. Incidentally, in the following description, radio waves from the portable terminal 200 are transmitted at specific intervals (for example, at 1 second intervals). In addition, it is presumed that the radio wave intensity detecting unit 115 of the MFP 100 detects the radio wave intensity (dBm) at a specific interval (for example, at 1 second intervals). Moreover, it is explained that when the intensity (dBm) of the radio waves detected by the radio wave intensity detecting unit 115 is not equal to or higher than a specific level (for example, −30 dBm (0.001 mW) or more), the system control unit 120 performs preparation to permit the user indicated by the user identification information to login. Furthermore, it is explained that when the intensity (dBm) of the radio waves detected by the radio wave intensity detecting unit 115 is equal to or higher than a specific level (for example, −30 dBm (0.001 mW) or more), the system control unit 120 permits the user indicated by the user identification information to login. In the following description, it is also explained that the user identification information included in the login request information from the portable terminal 200 is the user ID received from the MFP 100.

### (Step S201)

The system control unit 120 determines whether or not radio waves have been received.

In this case, when there is no notification for notifying that the radio waves have been received from the communication control unit 112, the system control unit 120 determines that radio waves have not been received (step S201: NO).

On the other hand, when there is a notification for notifying that the radio waves have been received from the communication control unit 112, the system control unit 120 determines that radio waves have been received (step S201: YES), and processing proceeds to step S202.

### (Step S202)

The system control unit 120 determines whether or not the login request information has been received.

In this case, when there is no notification for notifying that the login request information has been received from the communication control unit 112, the system control unit 120 determines that login request information has not been received (step S202: NO).

However, when there is a notification for notifying that the login request information has been received from the communication control unit 112, the system control unit 120 determines that login request information has been received (step S202: YES), and processing proceeds to step S203.

### (Step S203)

The system control unit 120 causes the radio wave intensity detecting unit 115 to detect the radio wave intensity (dBm).

From step S203 on, the radio wave intensity detecting unit 115, at specific intervals (for example, 1 second intervals), detects the radio wave intensity (dBm) transmitted at specific intervals (for example, 1 second intervals) from the portable terminal 200, and notifies the system control unit 120.

### (Step S204)

The system control unit 120 determines whether or not a detection result has been received.

In this case, when there is no notification from the radio wave intensity detecting unit 115, the system control unit 120 determines that a detection result has not been received (step S204: NO).

On the other hand, when there is a notification from the radio wave intensity detecting unit 115, the system control unit 120 determines that a detection result has been received (step S204: YES), and processing proceeds to step S205.

### (Step S205)

The system control unit 120 determines whether or not the intensity (dBm) of the radio waves received from the radio wave intensity detecting unit 115 is equal to or higher than a specific level.

In this case, when the system control unit 120 determines that the intensity (dBm) of the radio waves received from the radio wave intensity detecting unit 115 is equal to or higher than a specific level (for example, −30 dBm (0.001 mW) or more) (step S205: YES), processing proceeds to step S206.

On the other hand, when the system control unit 120 determines that the intensity (dBm) of the radio wave received from the radio field intensity detection unit 115 is not equal to or higher than a specific level (for example, −30 dBm (0.001 mW) or more) (step S205: NO), processing proceeds to step S207.

Here, a case where the system control unit 120 determines that the intensity (dBm) of the radio waves received from the radio wave intensity detecting unit 115 is equal to or higher than a specific level (for example, −30 dBm (0.001 mW) or more) will be described. In this case, it can be determined that the user is at a position close to the MFP 100 (a position within 1 m).

On the other hand, a case where the system control unit 120 determines that the intensity (dBm) of the radio waves received from the radio wave intensity detecting unit 115 is not equal to or higher than a specific level (for example, −30 dBm (0.001 mW) or more) will be described. In this case, it can be determined that the user is at a position far from the MFP 100 (a position over 1 m).

### (Step S206)

The system control unit 120 permits the user indicated by the user identification information to login.

In this case, the system control unit 120 permits the panel operation control unit 118 to accept instructions such as a printing instruction or the like from the panel unit 104.

### (Step S207)

After the system control unit 120 performs preparation for permitting the user indicated by the user identification information to login, processing proceeds to step S205.

In this way, in the present embodiment, the portable terminal 200, by the communication control unit 211 (first communication control unit) performs short-range wireless communication, by the biometric authenticating unit 217 performs biometric authentication of a user, and by the system control unit 218 (first system control unit) instructs the communication control unit 211 (first communication control unit) to transmit login request information including user identification information when the biometric authentication by the biometric authentication unit 217 is successful, and the MFP 100 (image forming apparatus), by the communication control unit 112 (second communication control unit) performs short-range wireless communication, and by the system control unit 120 (second system control unit) receives the login request information, and then permits the user indicated by the user identification information included in the login request information to login.

As a result, indirect biometric authentication becomes possible even in the case of a MFP 100 that does not have a biometric authentication function. This is possible by using the authentication result of the biometric authentication by the portable terminal without the addition of a biometric authenticating unit, updating of the firmware, data registration of biometric information called a template, and the like. As a result, it is possible to suppress an increase in operation cost due to an increase in man-hours related to addition of a biometric authenticating unit, update of firmware, data registration of biometric information called a template, and the like in a case where a biometric authentication function is added to the MFP 100 later.

In addition, in the present embodiment, the MFP 100 is applied as an image forming apparatus, however this technique is not limited to an MFP 100, and may be applied to a printer or a multifunctional printer.

In a secure printing system of a typical technique as described above, generation of printed matter is allowed by confirming that biometric information inputted by a biometric information input unit matches registered biometric information from a portable communication apparatus by biometric authentication, so the owner of the printed matter can reliably obtain the printed matter. By making it possible for the owner of the printed matter to reliably acquire the printed matter in this way, security against information leakage is enhanced.

Incidentally, in an image forming apparatus not equipped with a biometric authentication function, naturally, user authentication by biometric authentication cannot be performed. In this case, by adding a biometric authentication function later it is considered that biometric authentication may be performed even by an image forming apparatus not equipped with a biometric authentication function.

However, there is a problem that when a biometric authentication function is added later to an image forming apparatus not equipped with the biometric authentication function, the operation cost will increase. This is due to an increase in man-hours related to addition of a biometric authenticating unit, update of firmware, data registration of biometric information called a template, and the like.

With the user authentication system and the user authentication method according to the present disclosure, indirect biometric authentication becomes possible even in an image forming apparatus not equipped with a biometric authentication function. Therefore, it is possible to suppress an increase in operation cost due to an increase in man-hours related to addition of a biometric authenticating unit, update of firmware, data registration of biometric information called a template, and the like in a case where a biometric authentication function is added later.

What is claimed is:

1. A user authentication system, comprising:
a portable terminal; and
an image forming apparatus; wherein the portable terminal has:
a first communication control unit configured to perform short-range wireless communication;
a biometric authenticating unit configured to perform biometric authentication of a user; and
a first system control unit configured to issue an instruction to the first communication control unit to transmit login request information including user identification information when biometric authentication by the biometric authenticating unit is successful;
the image forming apparatus has:
a second communication control unit configured to perform short-range wireless communication; and
a second system control unit that, after receiving the login request information, is configured to permit a user indicated by the user identification information included in the login request information to login.

2. The user authentication system according to claim 1, wherein
the first communication control unit of the portable terminal is configured to perform short-range wireless communication using radio waves;
the image forming apparatus has a radio wave intensity detecting unit configured to detect the intensity of the radio waves; and
the second system control unit is configured to permit the login when the intensity of the radio waves detected by the radio wave intensity detecting unit is equal to or higher than a specific level.

3. The user authentication system according to claim 2, wherein the second system control unit is configured to
perform preparation for permitting the login when the intensity of the radio wave detected by the radio wave intensity detecting unit is less than a specific level; and
issue a warning notification via the second communication control unit to the portable terminal indicating that the user is at a distant location.

4. A user authentication method, wherein
a portable terminal has:
a step of performing short-range wireless communication by a first communication control unit;
a step of performing biometric authentication of a user by a biometric authenticating unit; and
a step of issuing an instruction by a first system control unit to the first communication control unit to transmit login request information including user identification information when biometric authentication by the biometric authenticating unit is successful; and
an image forming apparatus has:
a step of performing short-range wireless communication by a second communication control unit; and
a step of permitting by a second control unit a user indicated by the user identification information included in the login request information to login after receiving the login request information.
